(19) United States
(12) Patent Application Publication
(10) Pub. No.: US 2006/0077859 A1
(43) Pub. Date: Apr. 13, 2006

(54) Optical pickup

(75) Inventors: Masahiko Nishimoto, Settsu-shi (JP); Yasuyuki Kochi, Ibaraki-shi (JP); Shinichi Ijima, Takatsuki-shi (JP); Takuya Okuda, Kyoto-shi (JP); Masayuki Ono, Takatsuki-shi (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/238,139

(22) Filed: Sep. 29, 2005

(30) Foreign Application Priority Data
Sep. 29, 2004 (JP) 2004-283890

(51) Int. Cl. G11B 7/00

(52) U.S. Cl. 369/112.1; 369/112.01

(57) ABSTRACT

An optical pickup includes: two laser diodes respectively operable to emit optical beams having different wave lengths; a diffraction grating operable to diffract each optical beam to a zero order diffracted beam and plus and minus first order diffracted beams; a holographic optical element operable to diffract the beams reflected from a recording medium; and photoelectric devices operable to receive the beams diffracted by the holographic optical element, wherein a photoelectric device for generating a tracking error signal and a photoelectric device for generating a focus error signal are disposed on opposite sides with respect to the laser diodes so as to face each other.

### CROSS-REFERENCE TO RELATED APPLICATIONS

This application is based on application No. 2004-283890 filed in Japan, the contents of which are hereby incorporated by reference.

### BACKGROUND OF THE INVENTION

(1) Field of the Invention

The present invention relates to an optical pickup that records and reproduces information on an optical recording medium, which uses lights of different wavelengths for the recording and the reproduction. In particular, the present invention relates to a technique to obtain both a focus error signal and a tracking error signal with high stability.

(2) Description of the Related Art

In recent years, optical recording media, such as CDs (Compact Discs) and DVDs have become widespread. The optical recording media use lights of different wavelengths (e.g. 780 nm to 820 nm for CDs, and 635 nm to 680 nm for DVDs) to record and reproduce data. Considering convenience for users, it is preferable that one pickup can record and reproduce data on optical recording media that are based on different standards.

FIG. 1 is a perspective view showing a structure of an optical pickup according to a conventional art (see Japanese Patent Publication No. 3518457, for instance). As FIG. 1 shows, an optical pickup 1 includes light sources 101 and 102, a mirror 103, a holographic optical element 104, and photoelectric devices 105a to 105f.

The light sources 101 and 102 respectively output lights having wavelengths of 650 nm and 780 nm. The mirror 103 guides the lights emitted from the light sources 101 and 102 to the holographic optical element 104. The holographic optical element 104 includes diffraction regions 104a and 104b, which diffract the lights emitted from the light sources 101 and 102. The photoelectric devices 105a to 105f receive lights reflected from an optical recording medium 111.

The light emitted from the light source 101 enters the photoelectric devices 105a to 105d. A focus error signal can be generated from signals output from the photoelectric devices 105a to 105d by the Spot Size Detection (SSD) method, and a tracking error signal and a reproduction signal can be generated from the same signals by the Differential Phase Detection (DPD) method.

Regarding the light emitted from the light source 102, a focus error signal can be generated from signals output from the photoelectric devices 105a, 105b, 105e and 105f by the SSD method, and a tracking error signal and a reproduction signal can be generated from the same signals by the Three-Beam method or the Push-Pull (PP) method.

However, in the conventional art, it is difficult to obtain stable focus error signals and stable tracking signals from both of the light sources at the same time.

To record information on the optical recording medium, it is necessary to obtain the tracking error signal, by Differential Push-Pull (DPP) method or the like. However, also in this case, the stable signal is obtainable from only one of the light sources.

### SUMMARY OF THE INVENTION

The present invention is made in view of the above-described problem. The object of the present invention is to provide an optical pickup having a plurality of light sources that can obtain both focus error signal and tracking error signal with high stability, regardless of which light source is used.

The above object is fulfilled by an optical pickup that reads out information from an optical recording medium, comprising: two light emitting elements operable to emit optical beams respectively; a diffraction grating operable to diffract each optical beam to a zero order diffracted beam and plus and minus first order diffracted beams; a collimator lens operable to collimate the diffracted beams; an objective lens operable to focus the collimated beams on a recording surface of the optical recording medium; and a holographic optical element operable to diffract the beams reflected from the recording surface, wherein the holographic optical element has four diffraction regions, which are separated by two straight lines intersecting at right angles, each diffraction region having a different diffraction angle, and the holographic optical element is disposed so that principal rays of the zero order diffracted beams, which are diffracted by the diffraction grating and reflected from the recording surface, pass through an intersection point of the two straight lines.

With the stated structure, it is possible to generate the focus error signal and the tracking error signal with high stability, regardless of the type of the optical recording medium.

One of the light emitting elements may emit an optical beam having a shorter wavelength than a wavelength of an optical beam emitted from the other light emitting element, and a principal ray of a zero order diffracted beam, which is diffracted by the diffraction grating from the optical beam having the shorter wavelength, may pass through the intersection point on the holographic optical element before entering the optical recording medium. The standard of the optical recording medium requires higher optical accuracy as the wavelength of the optical beam decreases. With the stated structure, the required optical accuracy can be easily achieved.

Here, it is preferable that said one of the light emitting elements which emits the optical beam having the shorter wavelength, the collimator lens and the holographic optical element are arranged so that the principal ray of the optical beam having the shorter wavelength and an optical axis of the collimator lens pass through the intersection point on the holographic optical element.

The optical pickup may further comprise a ¼ retardation plate which is disposed in a light path from the holographic optical element to the optical recording medium, wherein the holographic optical element is a polarization holographic grating, which is disposed so as not to diffract the optical beams yet to reach the optical recording medium, but to diffract the optical beams already reflected from the recording medium. With the stated structure, the optical beams emitted from the light emitting elements are not diffracted by the holographic optical element before reaching the optical recording medium. This prevents the high order diffracted beams diffracted by the holographic optical element from becoming a stray lights and causing noises.

A distance between the collimator lens and the objective lens may be shorter than one half of a focal length of the collimator lens, and the collimator lens may be disposed in a light path from the objective lens to the holographic optical element. With the stated structure, the intensity axes of the optical beams, which are emitted from the two light emitting elements and reflected from the optical recording medium, can pass through the intersection point on the holographic optical element.

A distance between the collimator lens and the objective lens may be shorter than a sum of a focal length of the collimator lens and a focal length of the objective lens. Also with the stated structure, the intensity axes of the optical beams, which are emitted from the two light emitting elements and reflected from the optical recording medium, can pass through the intersection point on the holographic optical element.

Here, it is preferable that the distance between the collimator lens and the objective lens is longer than one half of the focal length of the collimator lens, and the holographic optical element is disposed in a light path from the objective lens to the collimator lens.

In each of the four diffraction regions, two types of diffraction sub-regions may be arranged alternately so as to form a stripe pattern. With the stated structure, the photoelectric devices, which are disposed so as to sandwich the light emitting elements, can receive the optical beams having passed through the sub-regions.

The optical pickup may further comprise photoelectric devices operable to receive the optical beams, which are emitted from the two light emitting elements and reflected from the optical recording medium. With the stated structure, it becomes unnecessary to prepare a photoelectric device for each light emitting element. This miniaturizes the circuit and the optical pickup.

The light emitting elements and the photoelectric devices may be mounted on a single IC substrate. With the stated structure, it becomes possible to assemble the light emitting elements and the photoelectric devices with high accuracy.

The optical pickup may further comprise: a casing having a cylindrical shape with a bottom; and a plate member which is translucent and covers an opening of the casing, wherein the casing contains the light emitting elements, the photoelectric devices and the IC substrate, and the diffraction grating is formed on the plate member. With the stated structure, it becomes possible to assemble the optical pickup more accurately.

A focus error signal and a tracking error signal may be generated from signals output by the photoelectric devices in accordance with intensities of the received optical beams. With the stated structure, it becomes possible to stably generate the focus error signal and the tracking error signal.

One of the light emitting elements may be a short wavelength light emitting element, which emits an optical beam having a shorter wavelength than a wavelength of an optical beam emitted from the other light emitting element which is a long wavelength light emitting element, a principal ray of a zero order diffracted beam diffracted by the diffraction grating from the optical beam having the shorter wavelength may pass through the intersection point on the holographic optical element before entering the optical recording medium, a focus error signal may be generated from a signal output from a photoelectric device, among the photoelectric devices, which is disposed on the other side of the long wavelength light emitting element with respect to the short wavelength light emitting element, and a tracking error signal may be generated from a signal output from a photoelectric device, among the photoelectric devices, which is disposed on the other side of the shot wavelength light emitting element with respect to the long wavelength light emitting element. With the stated structure, the circuit for generating the focus error signal and the circuit for generating the tracking error signal can be separated from each other. Accordingly, the circuit structures can be simplified.

The optical pickup may further comprise a converting and amplifying circuit operable to convert current signals output from the photoelectric devices to voltage signals, and amplify the voltage signals. With the stated structure, it becomes possible to reduce the harmful effect of the noise that might be caused while the optical pickup generates the focus error signal and the tracking error signal.

The light emitting elements, the photoelectric devices and the converting and amplifying circuit may be mounted on a single IC substrate. With the stated structure, it becomes possible to assemble the light emitting elements, the photoelectric devices and the current-voltage converting and amplifying circuits with high accuracy.

The two light emitting elements may constitute a monolithic laser diode. With the stated structure, it becomes possible to assemble the two light emitting elements with high accuracy such that the light emitting elements have a proper positional relationship with each other.

The diffraction grating may be separated by two substantially parallel straight lines into a center part and outer parts, a diffraction efficiency of the zero order diffracted beam may be higher in the center part than in the outer parts, and gratings formed on the outer parts may diagonally intersect the straight lines. With the stated structure, it becomes possible to improve the intensity of the zero order diffracted beam. This improves the efficiency of the recording and the reproduction of the optical recording medium. Here, it is preferable that the optical pickup records information on the optical recording medium and reproduces information recorded on the optical recording medium using the zero order diffracted beam which passes through the center part, and generates a focus error signal and a tracking error signal using the plus and minus first order diffracted beams which pass through the outer parts.

### BRIEF DESCRIPTION OF THE DRAWINGS

These and the other objects, advantages and features of the invention will become apparent from the following description thereof taken in conjunction with the accompanying drawings which illustrate a specific embodiment of the invention. In the drawings:

FIG. 1 is a perspective view showing a structure of an optical pickup according to a conventional art;

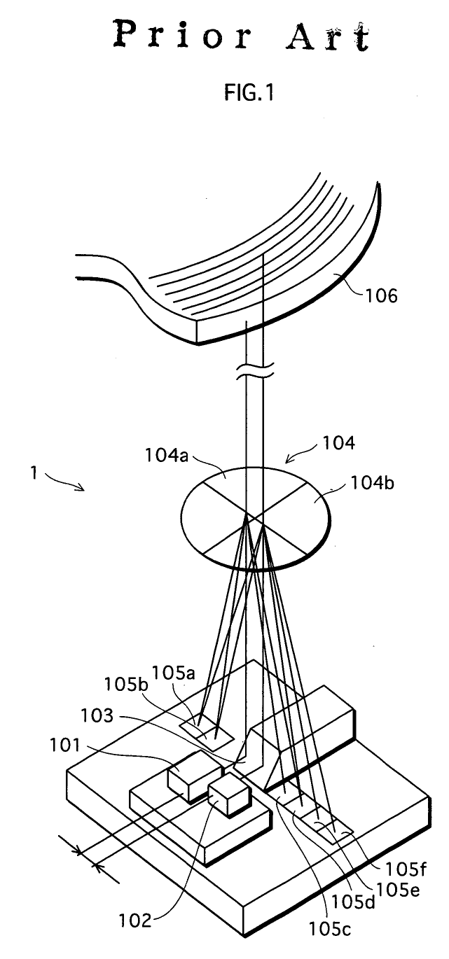

FIG. 2 is a sectional view schematically showing a structure of an optical pickup according to the first embodiment of the present invention;

FIG. 3 is a plan view schematically showing a structure of a holographic optical element 205 according to the first embodiment of the present invention;

FIG. 4 is a plan view schematically showing structures of photoelectric device groups 202a to 202c according to the first embodiment of the present invention;

FIG. 5A and FIG. 5B are sectional views schematically showing operations of an optical pickup 2 according to the first embodiment of the present invention, wherein FIG. 5A shows paths of lights respectively emitted from laser diodes 203a and 203b to an optical recording medium 210, and FIG. 5B shows paths of the lights, which are respectively emitted from the laser diodes 203a and 203b, reflected from the optical recording medium 210, and reach photoelectric device groups 202a to 202c;

FIG. 6 is a plan view showing spots of optical beams 501a and 501b entering photoelectric device groups 202a to 202c according to the first embodiment of the present invention;

FIG. 7 is a sectional view schematically showing a structure of an optical pickup according to the second embodiment of the present invention;

FIG. 8A and FIG. 8B are sectional views schematically showing paths of optical beams in an optical pickup 7 according to the second embodiment of the present invention, wherein FIG. 8A shows paths of lights respectively emitted from laser diodes 703a and 703b to an optical recording medium 710, and FIG. 8B shows paths of the lights, which are emitted from the laser diodes 703a and 703b, reflected from the optical recording medium 710 and reach photoelectric device groups 702a to 702c;

FIG. 9 is a sectional view schematically showing a structure of an optical pickup according to the third embodiment of the present invention;

FIG. 10 is a sectional view schematically showing a structure of an optical pickup according to the fourth embodiment of the present invention;

FIG. 11 is a plan view schematically showing a structure of a diffraction grating according to the fifth embodiment of the present invention;

FIG. 12 is a plan view schematically sowing a structure of an IC substrate included in an optical pickup according to the sixth embodiment of the present invention; and

FIG. 13 shows an equivalent circuit diagram of an IC substrate 12 according to the sixth embodiment of the present invention.

### DESCRIPTION OF THE PREFERRED EMBODIMENTS

The following describes an optical pickup according to preferred embodiments of the present invention, with reference to the drawings.

### 1. The First Embodiment

An optical pickup according to the first embodiment has two light emitting elements, and is able to obtain both a focus error signal and a tracking error signal with high stability, using a holographic optical element having four regions whose characteristics are different from each other.

(1) Structure of Optical Pickup

Firstly, the structure of the optical pickup according to the first embodiment is described.

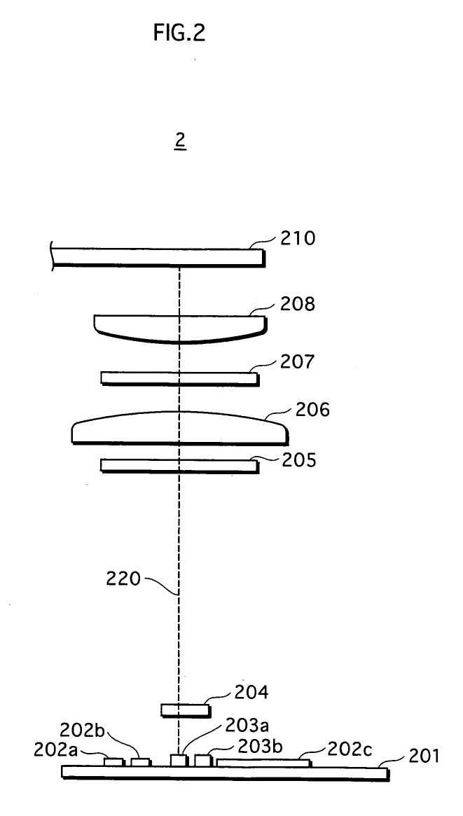

FIG. 2 is a sectional view schematically showing the structure of the optical pickup according to the first embodiment of the present invention.

As FIG. 2 shows, an optical pickup 2 includes an IC substrate 201, photoelectric device groups 202a to 202c, laser diodes 203a and 203b, a diffraction grating 204, a holographic optical element 205, a collimator lens 206, a ¼ retardation plate 207, and an objective lens 208. The optical pickup records information on an optical recording medium 210 or reproduces information recorded on the optical recording medium 210.

The laser diode 203a emits an optical beam which is in conformity with the DVD standard and has a wavelength of 650 nm. The laser diode 203b emits an optical beam which is in conformity with the CD Standard and has a wavelength of 780 nm.

The diffraction grating 204 diffracts the optical beams, which are emitted from the laser diodes 203a and 203b, to a zero order diffracted beam (a main beam) and a plus and minus first order diffracted beams (sub beams).

The holographic optical element 205 is a polarization holographic grating including four regions, which are separated by two straight lines intersecting at right angles. The four regions have diffraction angles different from each other. The holographic optical element 205 diffracts a light having a particular polarizing angle, but transmits a light having a polarizing angle that forms a right angle with the particular angle without diffracting.

The collimator lens 206 collimates the lights emitted from the laser diodes 203a and 203b.

The ¼ retardation plate 207 converts a linear polarized light to a circular polarized light, and vice versa.

The objective lens 208 focuses the lights emitted from the laser diodes 203a and 203b on the recording surface of the optical recording medium 210, and collimates the lights reflected from the optical recording medium 210.

The photoelectric device groups 202a to 202c receive the lights diffracted by the holographic optical element 205. The photoelectric device groups 202a and 202b are used for generating the tracking error signal, and the photoelectric device group 202c is used for generating the focus error signal. As described later, each of the photoelectric device groups 202a to 202c includes a plurality of photoelectric devices.

The photoelectric device groups 202a to 202c and the laser diodes 203a and 203b are mounted on the IC substrate 201.

(2) Structure of Holographic Optical Element 205

The structure of the holographic optical element 205 is described next.

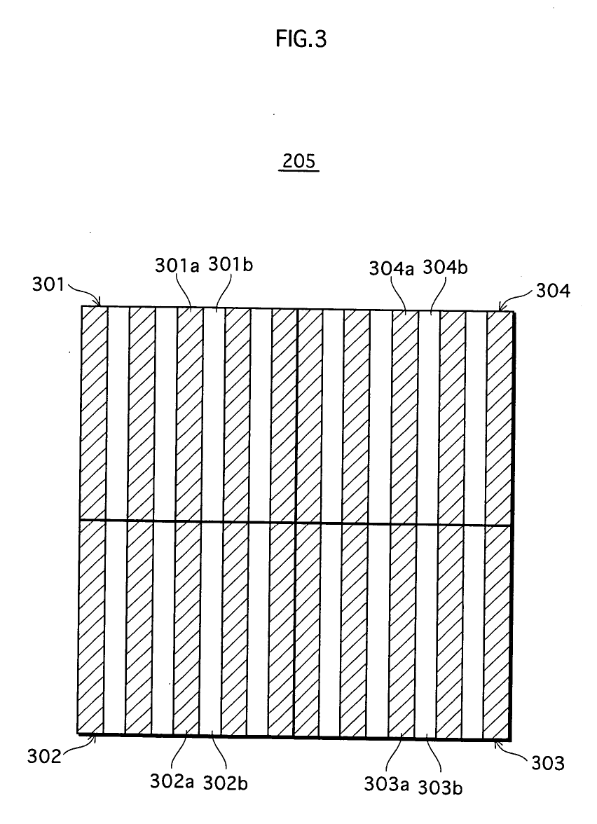

FIG. 3 is a plan view schematically showing the structure of the holographic optical element 205. As FIG. 3 shows, in the plan view, the holographic optical element 205 has a shape of a square as a whole, and separated into four rectangular regions 301 to 304 by two straight lines intersecting at right angles. The regions 301 to 304 have different diffraction angles. Each region includes two types of sub-regions having different diffraction angles.

As FIG. 3 shows, the region 301 includes hatched rectangular sub-regions (one of which is represented by a sign “301a”) and non-hatched rectangular sub-regions (one of which is represented by a sign “301b”). The sub-regions 301a and 301b are arranged alternately so as to form a stripe. In the same way, the region 302 includes sub-regions 302a and 302b, the region 303 includes sub-regions 303a and 303b, and the region 304 includes sub-regions 304a and 304b.

(3) Structures of Photoelectric Device Groups 202a to 202c

The structures of the photoelectric device groups 202a to 202c are described next.

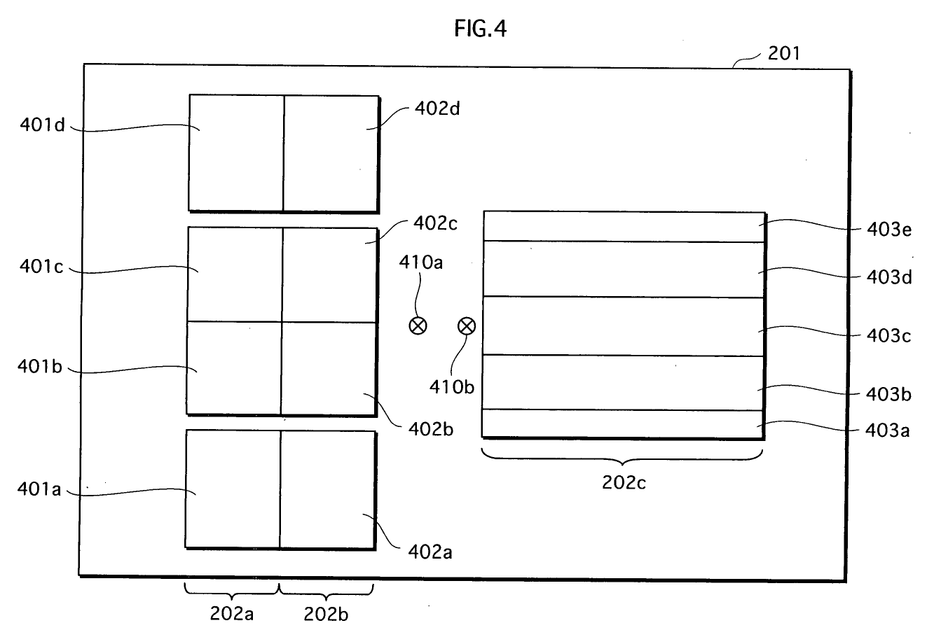

FIG. 4 is a plan view schematically showing the structures of the photoelectric device groups 202a to 202c. As FIG. 4 shows, the photoelectric device group 202a includes four photoelectric devices 401a to 401d, and the photoelectric device group 202b includes four photoelectric devices 402a to 402d. The photoelectric device group 202c includes five photoelectric devices 403a to 403e. Note that the crosses 410a and 410b respectively represent apparent radiant points of the laser diodes 203a and 203b.

(4) Arrangement of Optical Members

The arrangement of optical members included in the optical pickup 2 is described next.

As a broken line 220 in FIG. 2 shows, the members of the optical pickup 2 are arrange so that the principal ray of the emitted beam from the laser diode 203a, the center point of the holographic optical element 205, the optical axis of the collimator lens 206, and the optical axis of the objective lens 208 are substantially in the same straight line. Here, the center point of the holographic optical element 205 is the intersection point of the two straight lines that separates the holographic optical element 205 into the four regions.

With the arrangement described above, the principal ray of the emitted beam from the laser diode 203a passes through the center point of the holographic optical element 205. The principal ray of the beam emitted from the laser diode 203b passes through the border line between the regions 301 and 302 or the border line between the regions 303 and 304. Both of the principal rays of the beams, which are emitted from the laser diodes 203a and 203b, and reflected from the optical recording medium 210, pass through the center point of the holographic optical element 205. In other words, the optical members are arranged so that the intensity axes of the reflected lights pass through the center point of the holographic optical element 205.

In this case, if the focal length of the collimator lens 206 is f1, the distance between the collimator lens 206 and the objective lens 208 is less than one half of f1.

The lights emitted from the laser diodes 203a and 203b are liner polarized lights. The holographic optical element 205 is disposed so as not to diffract the lights emitted from the laser diodes 203a and 203b, but diffract the lights reflected from the optical recording medium 210.

As a modification, the ¼ retardation plate 207 may be disposed in the light path from the holographic optical element 205 to the collimator lens 206.

(5) Light Paths of Optical Beams in the Optical Pickup 2

The light paths of the optical beams in the optical pickup 2 are described next.

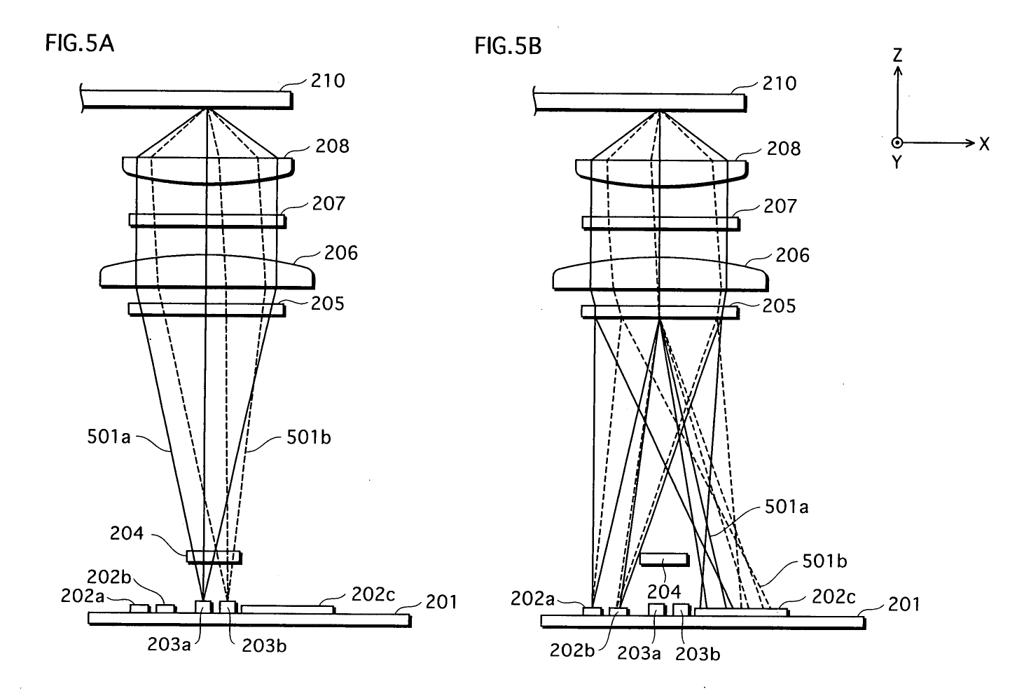

FIG. 5A and FIG. 5B are sectional views schematically showing operations of the optical pickup 2. FIG. 5A shows the paths of the lights respectively emitted from the laser diodes 203a and 203b to the optical recording medium 210. FIG. 5B shows the paths of the lights, which are respectively emitted from the laser diodes 203a and 203b, reflected from the optical recording medium 210, and reach the photoelectric device groups 202a to 202c. In both FIG. 5A and FIG. 5B, the solid lines represent the lights emitted from the laser diode 203a, and the broken lines represent the lights emitted from the laser diode 203b.

Needless to say, only one of the laser diodes 203a and 203b emits light according to the type of the optical recording medium 210, and the laser diodes 203a and 203b never emit lights at the same time. More specifically, the laser diode 203a emits light for recording data on a DVD or playing back data recorded on a DVD, and the laser diode 203b emits light for recording data on a CD or playing back data recorded on a CD.

As FIG. 5A shows, an optical beam 501a emitted from the laser diode 203a and an optical beam 501b emitted from the laser diode 203b are respectively diffracted to the zero order diffracted beam (a main beam) and the plus and minus first order diffracted beams (sub beams, not illustrated) by the diffraction grating 204. As described above, the optical beams 501a and 501b pass through the holographic optical element 205 without being diffracted, and are collimated by the collimator lens 206. Then, the optical beams 501a and 501b are converted to circular polarized lights by ¼ retardation plate 207 and focused on the recording surface of the optical recording medium 210 by the objective lens 208.

As FIG. 5B shows, the optical beams 501a and 501b reflected from the optical recording medium 210 are collimated by the objective lens 208, and converted to linear polarized lights by the ¼ retardation plate 207. Here, the polarizing angle of the linear polarized lights, which are generated from the optical beams 501a and 501b, form a right angle with the polarizing angle of the lights emitted from the laser diodes 203a and 203b. Then, the optical beams 501a and 501b enter the holographic optical element 205 via the collimator lens 206. Here, the principal rays of the optical beams 501a and 501b pass through the center point of the holographic optical element 205.

The optical beams 501a and 501b are diffracted by the holographic optical element 205, and change their respective direction towards the X direction. Here, the directions of the optical beams 501a and 501b respectively change in accordance with which regions of the holographic optical element 205 the optical beams 501a and 501b enter. That is to say, the plus and minus first order diffracted beams of the optical beams 501a and 501b, which have entered the region 301 and the region 302 of the holographic optical element 205, are guided to the photoelectric device groups 202a and 202c respectively. The plus and minus first order diffracted beams of the optical beams 501a and 501b, which have entered the region 303 and the region 304 of the holographic optical element 205, are guided to the photoelectric device groups 202b and 202c respectively.

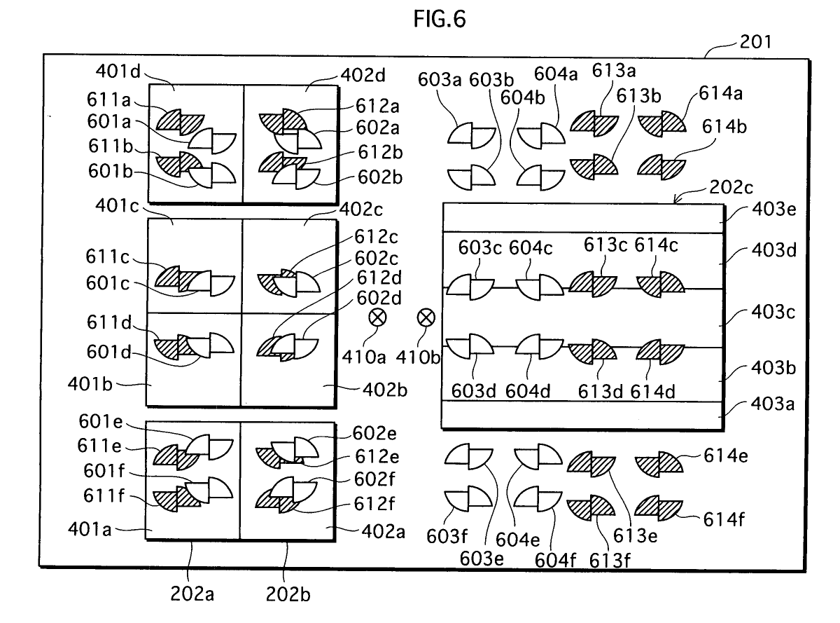

FIG. 6 is a plan view showing spots of the optical beams 501a and 501b entering the photoelectric device groups 202a to 202c. In FIG. 6, the non-hatched figures represent spots of the optical beam 501a, and the hatched figures represent spots of the optical beam 501b.

Portions of the main beam of the optical beam 501a, which are diffracted by the region 301 of the holographic optical element 205, respectively form spots 601c and 604d. Portions of the main beam of the optical beams 501a, which are diffracted by the region 302 of the holographic optical element 205, respectively form spots 601d and 604c. Portions of the main beam of the optical beams 501a, which are diffracted by the region 303 of the holographic optical element 205, respectively form spots 602d and 603c. Portions of the main beam of the optical beams 501a, which are diffracted by the region 304 of the holographic optical element 205, respectively form spots 602c and 603d.

Portions of the sub beam of the optical beam 501a, which are diffracted by the region 301 of the holographic optical element 205, respectively form spots 601a, 601e, 604b and 604f. Portions of the sub beam of the optical beams 501a, which are diffracted by the region 302 of the holographic optical element 205, respectively form spots 601b, 601f, 604a and 604e. Portions of the sub beam of the optical beams 501a, which are diffracted by the region 303 of the holographic optical element 205, respectively form spots 602b, 602f, 603a and 603e. Portions of the sub beam of the optical beams 501a, which are diffracted by the region 304 of the holographic optical element 205, respectively form spots 602a, 602e, 603b and 603f.

Portions of the main beam of the optical beam 501b, which are diffracted by the region 301 of the holographic optical element 205, respectively form spots 611c and 614d. Portions of the main beam of the optical beams 501b, which are diffracted by the region 302 of the holographic optical element 205, respectively form spots 611d and 614c. Portions of the main beam of the optical beams 501b, which are diffracted by the region 303 of the holographic optical element 205, respectively form spots 612d and 613c. Portions of the main beam of the optical beams 501b, which are diffracted by the region 304 of the holographic optical element 205, respectively form spots 612c and 613d.

Portions of the sub beam of the optical beam 501b, which are diffracted by the region 301 of the holographic optical element 205, respectively form spots 611a, 611e, 614b and 614f. Portions of the sub beam of the optical beams 501b, which are diffracted by the region 302 of the holographic optical element 205, respectively form spots 611b, 611f, 614a and 614e. Portions of the sub beam of the optical beams 501b, which are diffracted by the region 303 of the holographic optical element 205, respectively form spots 612b, 612f, 613a and 613e. Portions of the sub beam of the optical beams 501b, which are diffracted by the region 304 of the holographic optical element 205, respectively form spots 612a, 612e, 613b and 613f.

(6) Generation of Focus/Tracking Error Signal

The methods for generating the focus error signal and the tracking error signal are described next. The optical pickup 2 performs a focus servo control using the focus error signal, and performs a tracking servo control using the tracking error signal. Accordingly, the optical beams 501a and 501b can be focused on the predetermined position on the recording surface of the optical recording medium 210.

(a) Generation of Focus Error Signal

Firstly, the method for generating the focus error signal is described. In this embodiment, the focus error signal FE is generated according to the following formula, using the Spot Size Detection (SSD) method:
FE=F1−F2,
where F1 is the sum of the output signals from the photoelectric devices 403d and 403b, and F2 is the sum of the output signals from the photoelectric devices 403e, 403c and 403a.
(b) Generation of Tracking Error Signal

Next, the method for generating the tracking error signal is described. In this embodiment, the tracking error signal TE is generated using the Differential Phase Detection (DPD) method or the Differential Push-Pull (DPP) method. If the Differential Phase Detection method is used, the tracking error signal TE is generated according to the following formula:
TE=(Phase Comparison between T1 and T4)+(Phase Comparison between T2 and T3),
where the signs T1 to T4 are the output signals from the photoelectric devices 401c, 401b, 402b and 402c respectively.

If the Differential Push-Pull method is used, the tracking error signal TE is generated according to the following formula:
TE=(T1+T2)−(T3+T4)−k(T5−T6),
where the signs T1 to T4 are the same as those described above, and the sign T5 is the sum of the output signal from the photoelectric device 401d and the output signal from the photoelectric device 401a. The sign T6 is the sum of the output signal from the photoelectric device 402d and the output signal from the photoelectric device 402a. The sign k is a constant corresponding to the characteristic of the optical recording medium.
(7) Characteristics of Optical Pickup 2

The optical pickup 2 has the following characteristics.

As described above, the distance between the collimator lens 206 and the objective lens 208 is less than one half of the focal length f1 of the collimator lens 206. The principal ray of the beam emitted from the laser diode 203a is the same as the optical axis of the collimator lens 206.

Accordingly, the intensity axes of the reflected optical beams 501a and 501b pass through the center point of the holographic optical element 205. Therefore, the reflected optical beams 501a and 501b are equally divided into four optical beams, and enter the photoelectric device groups 202a to 202c. As a result, the focus error signal and the tracking error signal can be properly generated, regardless of the type of the optical recording medium.

Also, in the optical pickup 2, each of the regions 301 to 304 of the holographic optical element 205 includes the two types of the sub-regions having different diffraction angles, which are arranged so as to form a stripe pattern. Accordingly, two spots, namely a pre-focal-point diffraction spot, which is focused above the photoelectric devices, and a post-focal-point diffraction spot, which is focused below the photoelectric devices, enter the photoelectric devices.

Accordingly, the focus error signals for both of the lights emitted from the laser diodes 203a and 203b can be generated using only the photoelectric device group 202c. In the same manner, the tracking error signals for both of the lights emitted from the laser diodes 203a and 203b can be generated using the photoelectric device groups 202a and 202b. Therefore, the number of the photoelectric devices relating to the tracking error signals can be limited to eight, and the number of the photoelectric devices relating to the focus error signals can be limited to five. The signal processing system can be simplified as well.

The photoelectric device groups 202a and 202b relating to the tracking error signal, and the photoelectric device group 202c relating to the focus error signal are disposed so as to sandwich the laser diodes 203a and 203b. Therefore, the signal systems relating to the signals can be separated from each other.

As described above, the optical pickup 2 can stably generate the focus error signal and the tracking error signal.

Also, noises included in the focus/tracking error signal can be reduced, because the polarization holographic grating and the ¼ retardation plate 207 are used in the optical pickup 2 as described above. If a normal holographic grating is used instead of the polarization holographic grating 205, and the ¼ retardation plate 207 is removed, the lights emitted from the laser diodes 203a and 203b will be diffracted by the holographic grating before entering the optical recording medium 210. If the plus and minus first order diffracted beams generated by the diffraction enter the photoelectric devices as the stray lights, they will become noises. On the other hand, the optical pickup 2 does not generate such stray lights. Therefore, the optical pickup 2 can reduce the noise to be included in the focus/tracking error signal.

### 2. The Second Embodiment

The second embodiment of the present invention is described next. An optical pickup according to the second embodiment has almost the same structure as the structure of the optical pickup according to the first embodiment, but the arrangement of the optical devices is different. The following mainly describes the difference.

(1) Structure of Optical Pickup

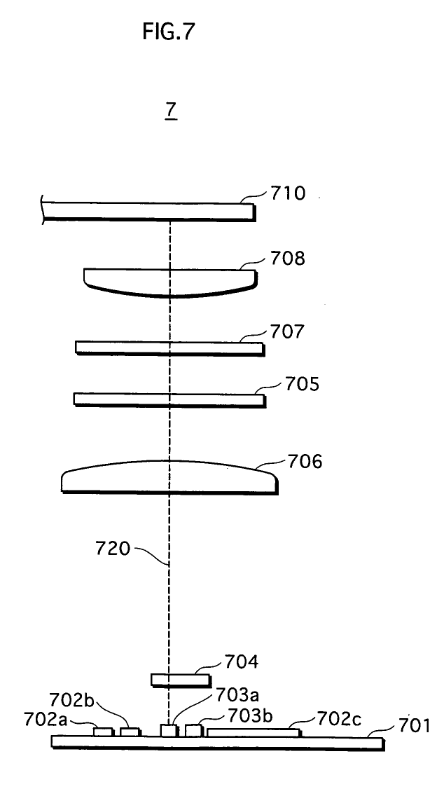

FIG. 7 is a sectional view schematically showing the structure of the optical pickup according to the second embodiment of the present invention. As FIG. 7 shows, an optical pickup 7 includes, just as the above-described optical pickup 2 includes, an IC substrate 701, photoelectric device groups 702a to 702c, laser diodes 703a and 703b, a diffraction grating 704, a holographic optical element 705, a collimator lens 706, a ¼ retardation plate 707, and an objective lens 708. The optical pickup records data on an optical recording medium 710 or reproduces data recorded on the optical recording medium 710.

The holographic optical element 705 is, just as the holographic optical element 205, a polarization holographic grating including four regions, which are separated by two straight lines intersecting at right angles. The four regions have diffraction angles different from each other. Each region includes two types of sub-regions which have different diffraction angles and are arranged so as to form a stripe.

The laser diode 703a emits an optical beam which is in conformity with the DVD standard and has a wavelength of 650 nm, and the laser diode 703b emits an optical beam which is in conformity with the CD Standard and has a wavelength of 780 nm. As a broken line 720 in FIG. 7 shows, the members of the optical pickup 7 are arrange so that the principal ray of the beam emitted from the laser diode 703a, the center point of the holographic optical element 705, the optical axis of the collimator lens 706, and the optical axis of the objective lens 708 are substantially in the same straight line.

In the first embodiment, the holographic optical element 205 is disposed in the light path from the diffraction grating 204 to the collimator lens 206. However, in the second embodiment, the holographic optical element 705 is disposed in the light path from the collimator lens 706 to the ¼ retardation plate 707.

The distance D between the collimator lens 706 and the objective lens 708 is within the following range:
f1/2<D<f1+f2,
where, f1 and f2 are the focal lengths of the collimator lens 605 and the objective lens 708 respectively. Since the collimator lens 706 and the objective lens 708 are arranged so as to satisfy the inequality above, the intensity axes of the zero order diffracted beams, which are generated by the diffraction grating 704 from the optical beams respectively emitted by the laser diodes 703a and 703b and reflected from the optical recording medium 710, intersect with each other in the light path from the objective lens 708 to the collimator lens 706. The holographic optical element 705 is disposed so that the center point of the holographic optical element 705 is at the intersection point of the intensity axes.
(2) Light Paths of Optical Beams in Optical Pickup 7

The light paths of the optical beams in the optical pickup 7 are described next.

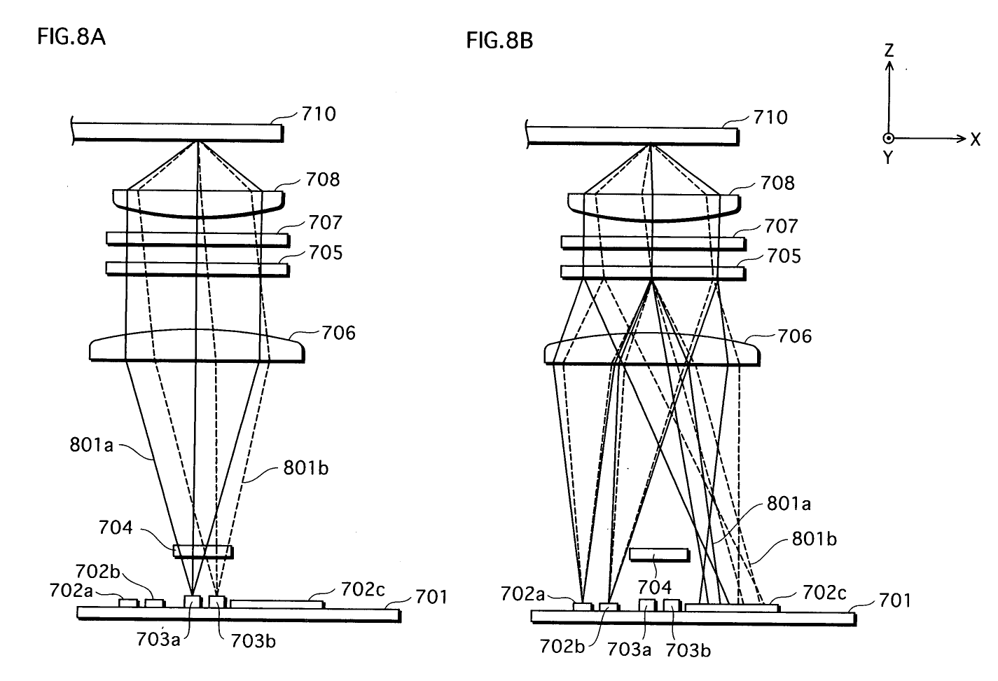

FIG. 8A and FIG. 8B are sectional views schematically showing the paths of the optical beams in the optical pickup 7. FIG. 8A shows the paths of the lights respectively emitted from the laser diodes 703a and 703b to the optical recording medium 710. FIG. 8B shows the paths of the lights which are emitted from the laser diodes 703a and 703b, reflected from the optical recording medium 710, and reach the photoelectric device groups 702a to 702c. In both FIG. 8A and FIG. 8B, the solid lines represent the lights emitted from the laser diode 703a, and the broken lines represent the lights emitted from the laser diode 703b.

As FIG. 8A shows, an optical beam 801a emitted from the laser diode 703a and an optical beam 801b emitted from the laser diode 703b are diffracted to the zero order diffracted beam (a main beam) and the plus and minus first order diffracted beams (sub beams, not illustrated) by the diffraction grating 704. As described above, the optical beams 801a and 801b are collimated by the collimator lens 706, and pass through the holographic optical element 705 without being diffracted. Then, the optical beams 801a and 801b are converted to circular polarized lights by ¼ retardation plate 707 and focused on the recording surface of the optical recording medium 710 by the objective lens 708.

As FIG. 8B shows, the optical beams 801a and 801b reflected from the optical recording medium 710 are collimated by the objective lens 708, and converted to linear polarized lights by the ¼ retardation plate 707. Here, the polarizing angles of the linear polarized lights, which are generated from the optical beams 801a and 801b, form a right angle with the polarizing angles of the lights emitted from the laser diodes 703a and 703b. Then, the optical beams 801a and 801b enter the collimator lens 706 via the holographic optical element 705. Here, the principal rays of the optical beams 801a and 801b pass through the center point of the holographic optical element 705.

The optical beams 801a and 801b are diffracted to the zero order diffracted beam and the plus and minus first order diffracted beams by the holographic optical element 705. Accordingly, the optical beams 801a and 801b change their respective direction towards the X direction, and the zero order diffracted beam and the plus and minus first order diffracted beams enter the photoelectric device groups 702a to 705c in the same manner as described in the first embodiment.

Therefore, the optical pickup 7 can realize the same effect as the optical pickup 2.

### 3. The Third Embodiment

The third embodiment of the present invention is described-next. An optical pickup according to the third embodiment has almost the same structure as the structure of the optical pickup according to the first embodiment, but the structure of the diffraction grating is different. The following mainly describes the difference.

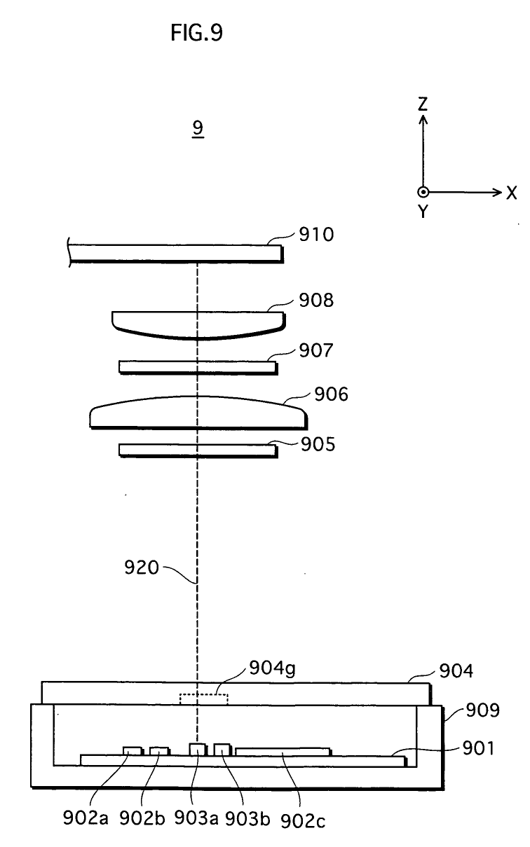

Firstly, the structure of the optical pickup is described. FIG. 9 is a sectional view schematically showing the structure of an optical pickup according to the third embodiment of the present invention. As FIG. 9 shows, an optical pickup 9 includes, just as the above-described optical pickup 2 according to the first embodiment includes, an IC substrate 901, photoelectric device groups 902a to 902c, laser diodes 903a and 903b, a holographic optical element 905, a collimator lens 906, a ¼ retardation plate 907 and an objective lens 908, and additionally includes a diffraction grating plate 904 and a package 909.

The package 909 has a cylindrical shape with a bottom. The IC substrate 901 and the photoelectric device groups 902a to 902c and the laser diodes 903a and 903b, which are mounted on the IC substrate 901, are fixed inside the package 909.

The diffraction grating plate 904 is made of glass or resin, and includes a diffraction grating 904g whose position corresponds to the position of the diffraction grating 204 of the optical pickup 2. The diffraction grating plate 904 is fixed to the package 909 so as to cover the opening of the package 909.

The positional relation among the laser diodes 903a, the diffraction grating 904g, the holographic optical element 905, the collimator lens 906, the ¼ retardation plate 907 and the objective lens 908 is the same as the above-described optical pickup 2.

With the stated structure, the number of parts included in the optical pickup can be reduced. Accordingly, it becomes possible to simplify and miniaturize the optical pickup, and assemble the pickup more accurately. It reduces the cost as well.

Note that the diffraction grating plate and the package are also applicable to the optical pickup according to the above-described second embodiment. This realizes the same effect.

### 4. The Fourth Embodiment

The fourth embodiment of the present invention is described next. An optical pickup according to the fourth embodiment has almost the same structure as the structure of the optical pickup according to the first embodiment, but the structures of the light emitting elements are different. The following mainly describes the difference.

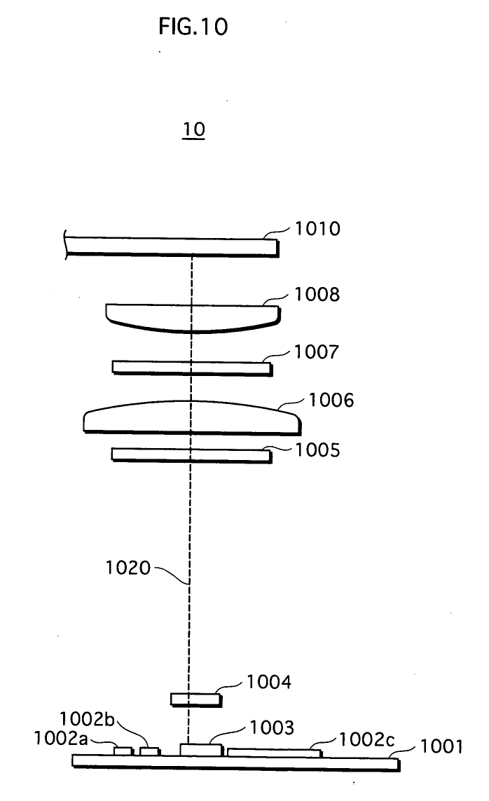

FIG. 10 is a sectional view schematically showing the structure of the optical pickup according to the fourth embodiment of the present invention. As FIG. 10 shows, an optical pickup 10 includes an IC substrate 1001, photoelectric device groups 1002a to 1002c, a laser diode 1003, a diffraction grating 1004, a holographic optical element 1005, a collimator lens 1006, a ¼ retardation plate 1007, and an objective lens 1008.

The laser diode 1003 according to the fourth embodiment of the present invention is a monolithic dual wavelength laser diode, in which two laser diodes are integrated.

The positional relationship among one of the laser diodes included in the laser diode 1003, which emits an optical beam having a shorter wavelength, the diffraction grating 1004, the holographic optical element 1005, the collimator lens 1006, the ¼ retardation plate 1007 and the objective lens 1008 is the same as the optical pickup 2 according to the above-described first embodiment.

With the stated structure, the possible error of the distance between two laser diodes is not more than the error of diffusion caused during the semiconductor process. This means that it becomes possible to assemble the pickup much more accurately. With the structure, it becomes also possible to shorten the distance between the two diodes. Accordingly, the optical pickup 10 can stably generate the focus error signal and the tracking error signal.

Needles to say, this structure is also applicable to the second embodiment and the third embodiment described above to gain the same effect.

### 5. The Fifth Embodiment

The fifth embodiment of the present invention is described next. An optical pickup according to the fifth embodiment has almost the same structure as the structure of the optical pickup according to the first embodiment, but the structure of the diffraction grating is different. The following mainly describes the difference.

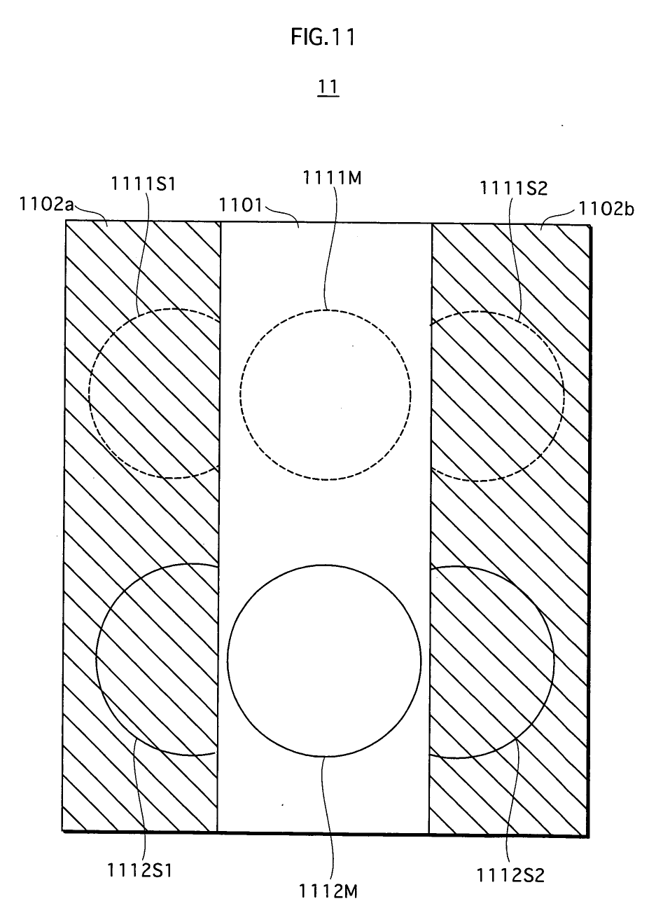

FIG. 11 is a plan view schematically showing the structure of a diffraction grating according to the fifth embodiment of the present invention. As FIG. 11 shows, a diffraction grating 11 has three regions, namely regions 1101, 1102a and 1102b, which are separated from each other by two parallel straight lines as the border lines. The regions 1102a and 1102b are diffraction grating regions, each including a diffraction grating, and the region 1101 is a non-grating region which does not include a diffraction grating.

One of the optical beams emitted from the laser diode, which has a longer wavelength, is diffracted by a diffraction grating 11 to a zero order diffracted beam 1111M, a plus first order diffracted beam 1111S1, and a minus first order diffracted beam 1111S2. The other one of the optical beams emitted from the laser diode, which has a shorter wavelength, is diffracted by the diffraction grating 11 to a zero order diffracted beam 1112M, a plus first order diffracted beam 1112S1, and a minus first order diffracted beam 1112S2.

In this case, the intensity axis of each optical beam passes through the non-grating region 1101. Accordingly, the intensity of the zero order diffracted beam is higher than the case where a diffraction grating is formed in the non-grating region 1101.

To improve the efficiency of the recording and the reproduction regarding the optical recording medium, it is necessary to improve the intensity of the zero order diffracted beam (the main beam). The fifth embodiment can heighten the intensity of the zero order diffracted beam, and thereby improve the efficiency of the recording and the reproduction.

Also, the depths of the gratings respectively included in the regions 1102a and 1102b are set to maximize the efficiencies of the plus and minus first order diffracted beams 1111S1, 1111S2, 1112S1 and 1112S2.

Accordingly, the fifth embodiment can improve the usability of the lights used in the optical pickup.

The gratings of the regions 1102a and 1102b may be formed so as to be diagonal to the border line between the regions 1102a and 1101, and the border line between the regions 1102b and the region 1101. Also, needless to say, the diffraction grating 11 having the stated structure is applicable to any of the optical pickups according to the second to fourth embodiments to gain the same effect.

### 6. The Sixth Embodiment

The sixth embodiment of the present invention is described next. An optical pickup according to the sixth embodiment has almost the same structure as the structure of the optical pickup according to the first embodiment, but the structure of the IC substrate is different. The following mainly describes the difference.

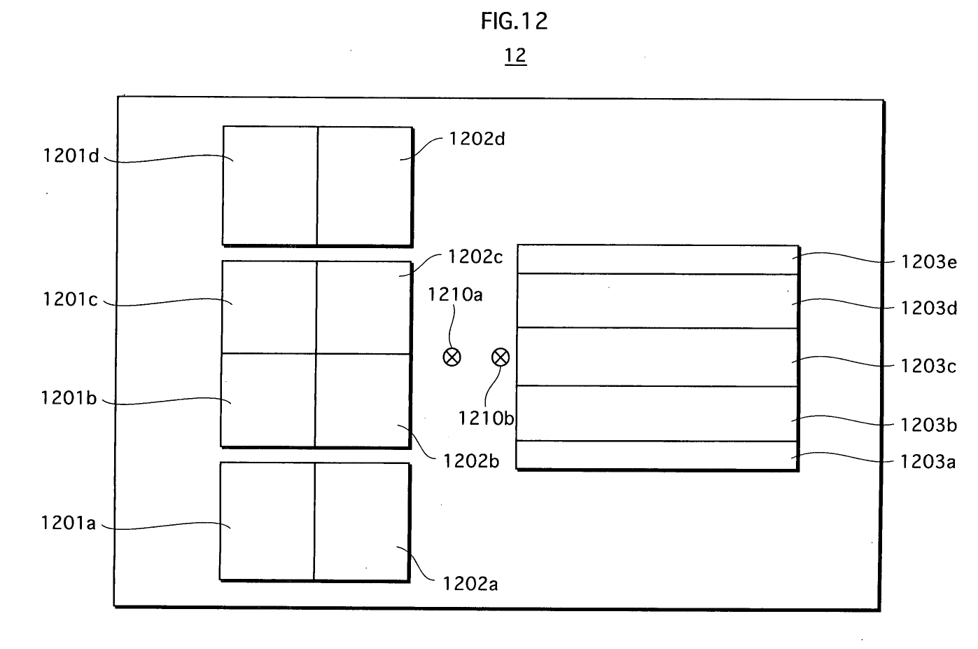

FIG. 12 is a plan view schematically showing the structure of an IC substrate included in an optical pickup according to the sixth embodiment of the present invention. As FIG. 12 shows, in the same manner as the IC substrate 201 according to the first embodiment, photoelectric devices 1201a to 1201d, 1202a to 1202d and 1203a to 1203e are disposed on an IC substrate 12 according to the sixth embodiment. As described later, the IC substrate 201 also includes current-voltage converting and amplifying circuits, which is not illustrated.

The photoelectric devices 1201a to 1201d, 1202a to 1202d and 1203a to 1203e respectively receive optical beams, which are reflected from the optical recording medium and diffracted by the holographic optical element. Note that the crosses 1210a and 1210b respectively represent apparent radiant points of the laser diodes.

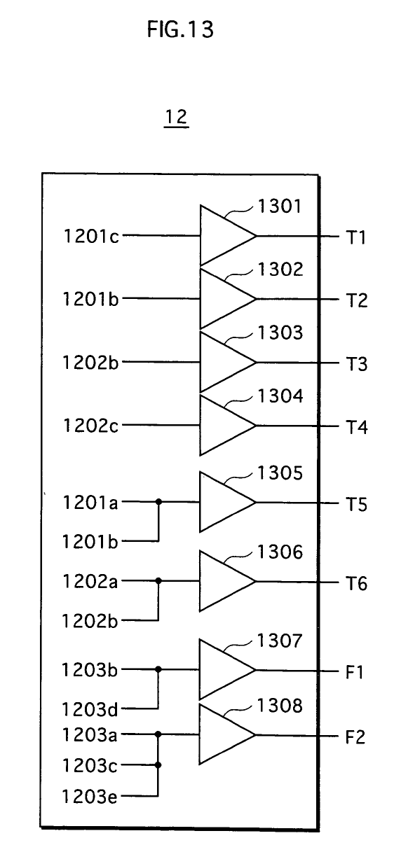

FIG. 13 shows an equivalent circuit diagram of the IC substrate 12 according to the sixth embodiment of the present invention. As FIG. 13 shows, the IC substrate 12 includes current-voltage converting and amplifying circuits 1301 to 1308 (hereinafter simply called “the circuits”).

The circuit 1301 converts and amplifies the signal output from the photoelectric device 1201c to generate a signal T1. The circuit 1302 converts and amplifies the signal output from the photoelectric device 1201b to generate a signal T2. The circuit 1303 converts and amplifies the signal output from the photoelectric device 1202b to generate a signal T3. The circuit 1304 converts and amplifies the signal output from the photoelectric device 1202c to generate a signal T4.

The circuit 1305 converts and amplifies the sum of the signals output from the photoelectric devices 1201a and 1201d to generate a signal T5. The circuit 1306 converts and amplifies the sum of the signals output from the photoelectric devices 1202a and 1202d to generate a signal T6.

The circuit 1307 converts and amplifies the sum of the signals output from the photoelectric devices 1203b and 1203d to generate a signal F1. The circuit 1308 converts and amplifies the sum of the signals output from the photoelectric devices 1203a and 1203e to generate a signal F2. As described above, the IC substrate 12 converts the current signals output from the photoelectric devices 1201a to 1201d, 1202a to 1202d and 1203a to 1203e to voltage signals using the circuits 1301 to 1308. This protects the output signals against external noises. Also, the circuits 1301 to 1308 are mounted on the IC substrate 12, which can improve the recording speed and the reproducing speed of the optical recording medium.

Needless to say, the IC substrate 12 is applicable to any of the optical pickups according to the second to fifth embodiments to gain the same effect.

### 7. Modification

The present invention is described above based on the embodiments. However, the present invention is not limited to the embodiments. The following is a possible modification. (1) Although not referred to in the above-described embodiments, the DVD standard may be any of the DVD, the DVD-ROM, the DVD-RAM, the DVD-R, the DVD-RW, and soon. In the same manner, the CD standard may be any of the CD, the CD-ROM, the CD-R, the CD-RW, and so on.

In the case where the optical pickup conforms to two standards, no matter what standards they are, the effect of the present invention can be gained with the following structure: Regarding one of the optical beams, which has the shorter wavelength, the lights reflected from the optical recording medium pass through the center point of the holographic optical element, and regarding the other one of the optical beams, which has the longer wavelength, the lights reflected from the optical recording medium pass thorough the borderlines between the diffraction regions formed on the holographic optical element.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. An optical pickup that reads out information from an optical recording medium, comprising:
two light emitting elements operable to emit optical beams respectively;
a diffraction grating operable to diffract each optical beam to a zero order diffracted beam and plus and minus first order diffracted beams;
a collimator lens operable to collimate the diffracted beams;
an objective lens operable to focus the collimated beams on a recording surface of the optical recording medium; and
a holographic optical element operable to diffract the beams reflected from the recording surface, wherein
the holographic optical element has four diffraction regions, which are separated by two straight lines intersecting at right angles, each diffraction region having a different diffraction angle, and
the holographic optical element is disposed so that principal rays of the zero order diffracted beams, which are diffracted by the diffraction grating and reflected from the recording surface, pass through an intersection point of the two straight lines.

2. The optical pickup of claim 1, wherein
one of the light emitting elements emits an optical beam having a shorter wavelength than a wavelength of an optical beam emitted from the other light emitting element, and
a principal ray of a zero order diffracted beam, which is diffracted by the diffraction grating from the optical beam having the shorter wavelength, passes through the intersection point on the holographic optical element before entering the optical recording medium.

3. The optical pickup of claim 2, wherein
said one of the light emitting elements which emits the optical beam having the shorter wavelength, the collimator lens and the holographic optical element are arranged so that the principal ray of the optical beam having the shorter wavelength and an optical axis of the collimator lens pass through the intersection point on the holographic optical element.

4. The optical pickup of claim 1, further comprising:
a ¼ retardation plate which is disposed in a light path from the holographic optical element to the optical recording medium, wherein
the holographic optical element is a polarization holographic grating, which is disposed so as not to diffract the optical beams yet to reach the optical recording medium, but to diffract the optical beams already reflected from the recording medium.

5. The optical pickup of claim 1, wherein
a distance between the collimator lens and the objective lens is shorter than one half of a focal length of the collimator lens, and
the collimator lens is disposed in a light path from the objective lens to the holographic optical element.

6. The optical pickup of claim 1, wherein
a distance between the collimator lens and the objective lens is shorter than a sum of a focal length of the collimator lens and a focal length of the objective lens.

7. The optical pickup of claim 6, wherein
the distance between the collimator lens and the objective lens is longer than one half of the focal length of the collimator lens, and
the holographic optical element is disposed in a light path from the objective lens to the collimator lens.

8. The optical pickup of claim 1, wherein
in each of the four diffraction regions, two types of diffraction sub-regions are arranged alternately so as to form a stripe pattern.

9. The optical pickup of claim 1, further comprising:
photoelectric devices operable to receive the optical beams, which are emitted from the two light emitting elements and reflected from the optical recording medium.

10. The optical pickup of claim 9, wherein
the light emitting elements and the photoelectric devices are mounted on a single IC substrate.

11. The optical pickup of claim 10, further comprising:
a casing having a cylindrical shape with a bottom; and
a plate member which is translucent and covers an opening of the casing, wherein
the casing contains the light emitting elements, the photoelectric devices and the IC substrate, and
the diffraction grating is formed on the plate member.

12. The optical pickup of claim 9, wherein
a focus error signal and a tracking error signal are generated from signals output by the photoelectric devices in accordance with intensities of the received optical beams.

13. The optical pickup of claim 12, wherein
one of the light emitting elements is a short wavelength light emitting element, which emits an optical beam having a shorter wavelength than a wavelength of an optical beam emitted from the other light emitting element which is a long wavelength light emitting element,
a principal ray of a zero order diffracted beam diffracted by the diffraction grating from the optical beam having the shorter wavelength passes through the intersection point on the holographic optical element before entering the optical recording medium,
a focus error signal is generated from a signal output from a photoelectric device, among the photoelectric devices, which is disposed on the other side of the long wavelength light emitting element with respect to the short wavelength light emitting element, and
a tracking error signal is generated from a signal output from a photoelectric device, among the photoelectric devices, which is disposed on the other side of the short wavelength light emitting element with respect to the long wavelength light emitting element.

14. The optical pickup of claim 13, further comprising
a converting and amplifying circuit operable to convert current signals output from the photoelectric devices to voltage signals, and amplify the voltage signals.

15. The optical pickup of claim 14, wherein
the light emitting elements, the photoelectric devices and the converting and amplifying circuit are mounted on a single IC substrate.

16. The optical pickup of claim 1, wherein
the two light emitting elements constitute a monolithic laser diode.

17. The optical pickup of claim 1, wherein
the diffraction grating is separated by two substantially parallel straight lines into a center part and outer parts,
a diffraction efficiency of the zero order diffracted beam is higher in the center part than in the outer parts, and
gratings formed on the outer parts diagonally intersect the straight lines.

18. The optical pickup of claim 17, wherein
the optical pickup records information on the optical recording medium and reproduces information recorded on the optical recording medium using the zero order diffracted beam which passes through the center part, and generates a focus error signal and a tracking error signal using the plus and minus first order diffracted beams which pass through the outer parts.
